(19) United States
(12) Patent Application Publication
(10) Pub. No.: US 2025/0307526 A1
(43) Pub. Date: Oct. 2, 2025

(54) GENERATIVE STYLE TOOL FOR CONTENT SHAPING

(71) Applicant: Microsoft Technology Licensing, LLC, Redmond, WA (US)

(72) Inventors: Nathalie M. RICHE, Issaquah, WA (US); Michel PAHUD, Kirkland, WA (US); Nicolai MARQUARDT, Sammamish, WA (US); Kenneth P. HINCKLEY, Kirkland, WA (US); Hugo K. D. ROMAT, Seattle, WA (US); Alemayehu SEYED, Redmond, WA (US)

(73) Assignee: Microsoft Technology Licensing, LLC, Redmond, WA (US)

(21) Appl. No.: 18/622,675

(22) Filed: Mar. 29, 2024

(51) Int. Cl. G06F 40/103; G06F 3/0482; G06F 3/0484; G06F 40/166

(52) U.S. Cl. CPC G06F 40/103; G06F 3/0482; G06F 3/0484; G06F 40/166

(57) ABSTRACT

Systems and methods for content shaping using one or more generative styles are provided. In particular, a computing device may determine the one or more generative styles applicable to at least a portion of content based on the content and the context associated with the content, the one or more generative styles representing one or more style features adapted to shape the at least a portion of the content, generate first user interface elements representing the one or more generative styles based on the content and the context associated with the content, receive a first generative style selected from the one or more generative styles via the first user interface elements, apply the selected generative style to a selected portion of the content, and cause a display of the content transformed based on the selected generative style.

### BACKGROUND

Computing devices include a variety of productivity tools and information that facilitate the accomplishment of a variety of tasks, including transforming content. For example, a productive tool allows users to create and edit content (e.g., image and text) based on users' instructions for deterministic outputs. However, it may be challenging for the users to conveniently and efficiently ideate styles for creating and shaping the content.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, a generative style tool allows users to ideate styles for creating and shaping content. When the generative style tool detects content that may be editable, the generative style tool generates one or more generative styles that are applicable to at least a portion of the content based on the content and context associated with the content using a generative large language model (LLM), a transformer model, a diffusion model, or a multi-modal model, other type of machine learning models, or a combination of models. For example, the generative style includes a natural language prompt describing one or more tasks to be performed on the content. Additionally, the generative style tool further generates user interface elements that represent the one or more generative styles based on the content and the context using a generative large language model (LLM), a transformer model, a diffusion model, or a multi-modal model, other type of machine learning models, or a combination of models.

In accordance with at least one example of the present disclosure, a method for content shaping using one or more generative styles is provided. The method may include determining the one or more generative styles applicable to at least a portion of content based on the content and the context associated with the content, the one or more generative styles representing one or more style features adapted to shape the at least a portion of the content, generating first user interface elements representing the one or more generative styles based on the content and the context associated with the content, receiving a first generative style selected from the one or more generative styles via the first user interface elements, applying the selected generative style to a selected portion of the content, and causing a display of the content transformed based on the selected generative style.

In accordance with at least one example of the present disclosure, a computing device for content shaping using one or more generative styles is provided. The computing device may include a processor and a memory having a plurality of instructions stored thereon that, when executed by the processor, causes the computing device to determine the one or more generative styles applicable to at least a portion of content based on the content and the context associated with the content, the one or more generative styles representing one or more style features adapted to shape the at least a portion of the content, generate first user interface elements representing the one or more generative styles based on the content and the context associated with the content, receive a first generative style selected from the one or more generative styles via the first user interface elements, apply the selected generative style to a selected portion of the content, and cause a display of the content transformed based on the selected generative style.

In accordance with at least one example of the present disclosure, a method for content shaping using one or more generative styles is provided. The method may include determining the one or more generative styles applicable to at least a portion of content created in an application based on the content and the context associated with the content, the one or more generative styles representing one or more style features adapted to shape the at least a portion of the content, generating first user interface elements representing the one or more generative styles based on the content and the context associated with the content, causing a display of the first user interface elements, receiving a first generative style selected from the one or more generative styles via the first user interface elements, determining whether one or more variations of the first generative style exist, in response to determining that the one or more variations of the first generative style exist, generating a second user interface element representing the one or more variations of the first generative style, and causing a display of the second user interface elements.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example of an operating environment in which a generative style tool may be implemented in accordance with examples of the present disclosure;

FIGS. 2A and 2B depict a flowchart of an example method of content shaping using one or more generative styles in accordance with examples of the present disclosure;

FIGS. 3A-3E depict screenshots of user interface elements of the generative style tool in accordance with examples of the present disclosure;

FIGS. 4A and 4B illustrate overviews of an example generative machine learning model that may be used in accordance with examples of the present disclosure;

FIG. 5 is a block diagram illustrating example physical components of a computing device with which aspects of the disclosure may be practiced;

FIG. 6 is a simplified block diagram of a computing device with which aspects of the present disclosure may be practiced; and

FIG. 7 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Computing devices include a variety of productivity tools and information that facilitate the accomplishment of a variety of tasks, including transforming content. For example, a productive tool allows users to create and edit content (e.g., image and text) based on users' instructions for deterministic outputs. However, it may be challenging for the users to conveniently and efficiently ideate styles for creating and shaping the content.

In accordance with examples of the present disclosure, a generative style tool allows users to ideate styles for creating and shaping content. When the generative style tool detects content that may be editable, the generative style tool generates one or more generative styles that are applicable to at least a portion of the content based on the content and context associated with the content using a generative large language model (LLM), a transformer model, a diffusion model, or a multi-modal model, other type of machine learning models, or a combination of models. For example, the generative style includes a natural language prompt describing one or more tasks to be performed on at least a portion of the content. Each generative style represents one or more prompts that define one or more style features adapted to shape at least a portion of the content. Once a user selects a generative style, the generative style tool may further generate variations of the selected generative style to, for example, provide more variations and/or refine the effect of the selected generative style. In some aspects, the user may modify any of the generative styles created by the generative style tool or combine two or more generative styles into a single generative style.

In accordance with examples of the present disclosure, the generative style tool further generates user interface elements that represent the generative styles based on the content and the context using a generative large language model (LLM), a transformer model, a diffusion model, or a multi-modal model, other type of machine learning models, or a combination of models. For example, user interface elements of the generative style tool are customized based on the actual content and the context associated with the content to provide unique look and feel of the generative style tool. The context may include a type of document that contains the content.

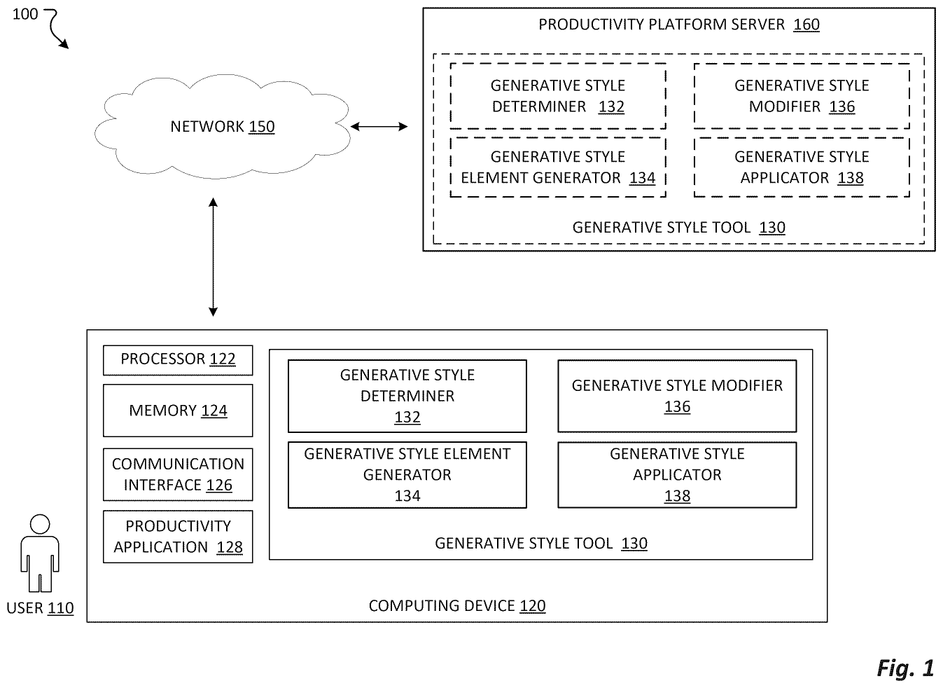

FIG. 1 depicts a block diagram of an example of an operating environment 100 in which a generative style tool may be implemented in accordance with examples of the present disclosure. To do so, the operating environment 100 includes a computing device 120 associated with the user 110. The computing device 120 may be, but is not limited to, a computer, a notebook, a laptop, a mobile device, a smartphone, a tablet, a portable device, a wearable device, or any other suitable computing device that is capable of executing the generative style tool 130. The operating environment 100 may further include one or more remote devices, such as a productivity platform server 160, that are communicatively coupled to the computing device 120 via a network 150. The network 150 may include any kind of computing network including, without limitation, a wired or wireless local area network (LAN), a wired or wireless wide area network (WAN), and/or the Internet.

The computing device 120 includes a productivity application 128 and a generative style tool 130 executing on a computing device 120 having a processor 122, a memory 124, and a communication interface 126. Specifically, the generative style tool 130 is communicatively coupled to the productivity application 128 to provide generative styles applicable to content created, generated, or otherwise appear in the productivity application 128.

The productivity application 130 allows the user 100 to create content. For example, the productivity application 128 may be a word processing application, a notebook application, a presentation application, a spreadsheet application, an email application, an internet browser application, an instant messaging or chat application, a social networking application, or any other application capable of creating content. The content may be one or more texts, documents, images, pictures, photos, videos, or audios.

The generative style tool 130 is configured to generate one or more generative styles to allow users to access and apply generative styles to at least a portion of content efficiently and effectively for shaping the content. In some embodiments, the generative style tool 130 may be a ribbon that appears as a part of user interface elements of the productivity application 128. In certain embodiments, the generative style tool 130 may be appear as a floating layer or a popup window on top of the productivity application 128. To do so, the generative style tool 130 further includes a generative style determiner 132, a generative style element generator 134, a generative style modifier 136, and a generative style applicator 138.

The generative style determiner 132 is configured to determine one or more generative styles that are applicable to at least a portion of the content. Specifically, the generative style determiner 132 is configured to determine the one or more generative styles based on the content and context associated with the content using a machine learning model. For example, the machine learning model may be a generative large language model (LLM), a transformer model, a diffusion model, or a multi-modal model, other type of machine learning models, or a combination of models. For example, each generative style represents one or more prompts that define one or more style features adapted to shape at least a portion of the content. The one or more style features may include generating, formatting, and/or styling text, an image, a table, a graph, an audio, a video, a 3D object, interactive content, and/or other data based on the at least a portion of the content. It should be appreciated the selected portion of the content may include multiple types of data (e.g., text, an image, a table, a graph, an audio, a video, a 3D object, and/or interactive content) and the same generative style may be applied to the multiple types of data.

To do so, the generative style determiner 132 is configured to determine a type of content, a genre or tone of content, a general topic or theme of content, and/or information contained in the content. For example, the type of content includes, but not limited to, one or more documents, spreadsheets, blog posts, emails, text messages, social media content, guides, books, video content, webinars, white papers, press releases, and/or case studies. The genre or tone of content includes, but not limited to, one or more news, social, media studies, fiction, non-fiction, essay, documentary, philosophical, humor, comedy, mystery, scientific, historical, horror, thriller, cartoons, and/or children. A general topic or theme of content includes, but not limited to, one or more technology, lifestyle, health, fitness, sports, food, cooking, beauty, business, education, family, parenting, travel, home, gardening, crafts, environment, gaming, and/or entertainment.

Additionally, the generative style determiner 132 is further configured to determine the context associated with the content. For example, the context may include a type of the productivity application, user's preferences, and/or user's expectations. The type of productivity application includes, but not limited to, a word processing application, a notebook application, a presentation application, a spreadsheet application, an email application, an internet browser application, an instant messaging or chat application, and/or a social networking application. Additionally, the user's preferences and expectations may be inferred based on the content. For example, the generative style determiner 132 may determine a user's particular use of style and knowledge from previous/historical contents and suggest generative styles and/or patterns related to the user based on the learned preferences and/or expectations. In other example, the generative style determiner 132 may determine a type of content that the user is working on and provide suggestions accordingly. For example, if the generative style determiner 132 determines that the user is drafting a patent application, the generative style determiner 132 may suggest appropriate generative styles and language for drafting patent applications.

According to some embodiments, the context may further include context of the user. For example, the context of the user may include a mood of the user (e.g., captured from a camera communicatively coupled to the computing device 120), one or more devices used (e.g., a tablet, a desktop, a large display screen), an environment of the user (e.g., on a bus, in a conference room, in a meeting), and/or a mood or ambiance of the environment (e.g., professional, casual) could affect what generative styles are generated and how many generative styles are provided to the user.

In some embodiments, the generative style determiner 132 is configured to generate one or more generative styles specific for a portion of the content selected by a user. For example, the user may select a portion of the content, and the generative style determiner 132 generates one or more generative styles that are applicable to the selected portion of the content.

In certain embodiments, the generative style determiner 132 is configured to generate a new generative style upon receiving a request from a user. For example, the user may select a portion of content to create a new generative style, and the generative style determiner 132 is configured to analyze the selected portion of content and determine any style features applied to the selected portion of content. Subsequently, the generative style determiner 132 is configured to generate a generative style that represents the style features, such that the user may apply the same style to a different portion of the content. It should be appreciated that, in certain embodiments, the generative style determiner 132 may allow users to create a new generative style from content of a different application (e.g., different from the productivity application that contains the content detected in the operation 204).

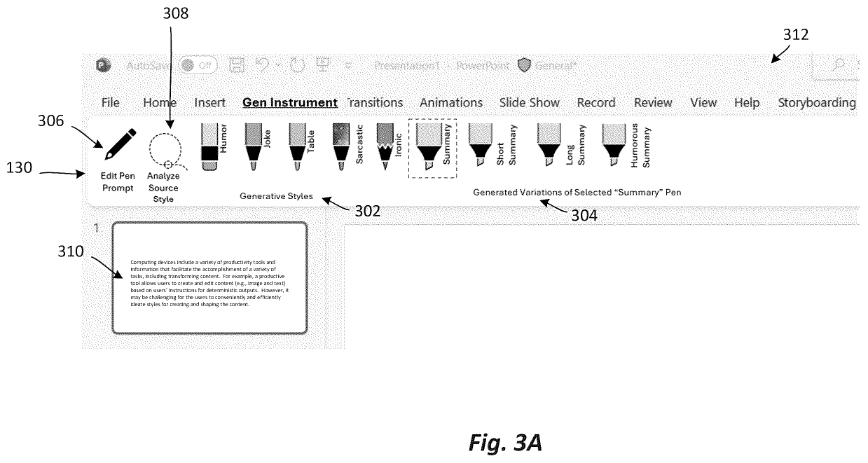

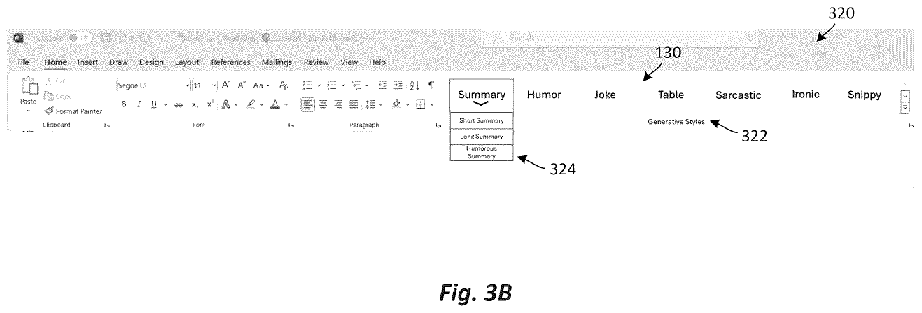

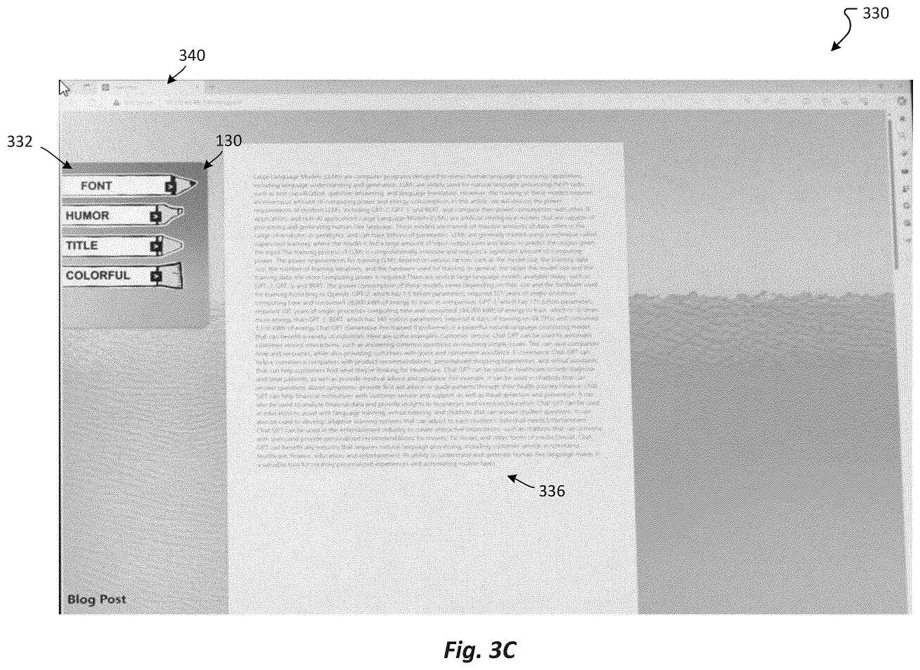

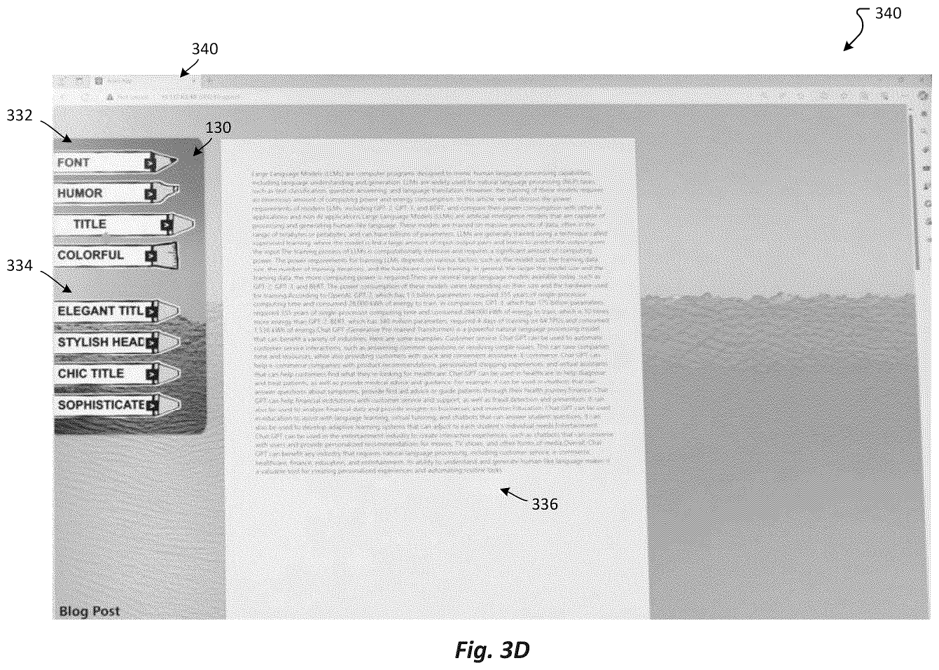

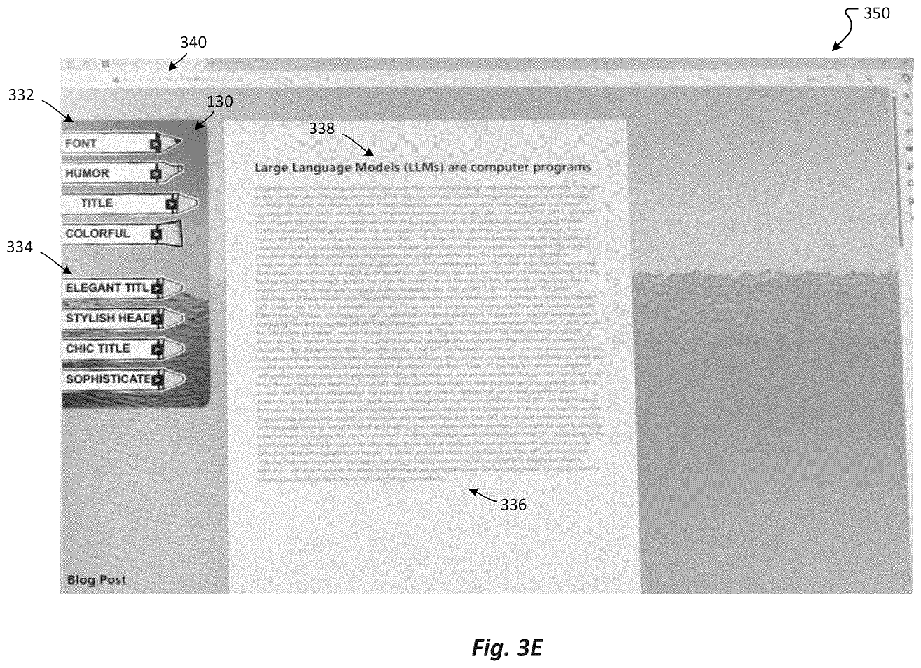

Additionally, the generative style determiner 132 is further configured to determine whether one or more variations of the generative style selected by the user exist, and if so, generate one or more variations of the selected generative style using a machine learning model. For example, the machine learning model may be a generative large language model (LLM), a transformer model, a diffusion model, or a multi-modal model, other type of machine learning models, or a combination of models. The one or more variations provide additional options that further refine the initially selected generative style. For example, as shown in the exemplary screenshots of the generative style tool 130 in FIGS. 3A and 3B, the first set of the user interface elements (e.g., “Humor”, “Joke”, “Table”, “Sarcastic”, “Ironic”, and “Summary”) is generated. It should be appreciated that, in some embodiments, there may be multi-level variations of the selected generative style. In such embodiments, the generative style determiner 132 further determines whether there are variations of the one or more variations of the generative style.

The generative style element generator 134 is configured to generate a first set of user interface elements that represent the one or more generative styles. Specifically, the generative style element generator 134 is configured to generate the first set of user interface elements based on the content and context associated with the content using a machine learning model. For example, the machine learning model may be a generative large language model (LLM), a transformer model, a diffusion model, or a multi-modal model, other type of machine learning models, or a combination of models. Each user interface element represents the corresponding generative style and adapts to provide appropriate look and feel of the user interface elements of the first user interface elements based on the content and the context. For example, each generative style may be represented with a different look and feel of the user interface element. Various exemplary screenshots of the generative style tool 130, which includes the first user interface elements representing the generative styles, are illustrated in FIGS. 3A-3E.

Additionally, the generative style element generator 134 is further configured to generate a second set of user interface elements that represent the one or more variations of the selected generative style. The second set of user interface elements may be generated based on the content, the context associated with the content, and the user interface element of the selected generative style using a machine learning model. For example, the machine learning model may be a generative large language model (LLM), a transformer model, a diffusion model, or a multi-modal model, other type of machine learning models, or a combination of models. Additionally, in some embodiments, the generative style element generator 134 may further generate additional sets of user interface elements in instances where there are multi-level variations of the selected generative style.

As illustrated in the exemplary screenshots of the generative style tool 130 in FIGS. 3A and 3B, the second set of user interface elements may look and feel similar to the selected generative style from the first set of user interface elements to indicate the selected generative style to which the second set of user interface elements belongs or relates. For example, designs (e.g., colors, shapes, layout, and typefaces) and behaviors (e.g., buttons, boxes, and menus) of the second set of user interface elements may be similar to the first set of user interface elements. The similar look and feel between the first and second sets of user interface elements are easily perceived by the user. However, it should be appreciated that, in some embodiments, the second set of user interface elements may look and feel different from the first set of user interface elements to distinguish the selections of the variations from the initial first set of the user interface elements.

The generative style modifier 136 is configured to receive a modification request to a selected generative style. The user can input or write any prompt (e.g., natural language prompts defining one or more style features) directly on the user interface element that correspond to the selected generative style. In some embodiments, the generative style modifier 136 is configured to update the variations of the modified generative style accordingly. For example, the modified generative style may be “Table with Columns”, “Emphasize a word”, or “Yellow Highlighter with blue underline.” Additionally, the user may combine two or more generative styles into a single generative style (e.g., a single user interface element) by dragging a first user interface element that corresponds to a first generative style to a second user interface element that corresponds to a second generative style to modify the second generative style into the combination of the first and second generative styles. Additionally, the generative style modifier 136 is configured to change the second user interface element to represent the combined generative styles.

The generative style applicator 138 is configured to apply the selected generative style to a selected portion of the content to shape the selected portion of the content according to the one or more style features defined by the selected generative style. To do so, the generative style applicator 138 is configured to receive a selection of at least a portion of the content to which the selected generative style is to be applied. For example, the user may select text or brushing over an area of an image to apply the selected generative style. Alternatively, the user may select a portion of the content before selecting the generative style to be applied. In some examples, the user may select background of content field of the productivity application to apply the selected generative style to the whole content. As described above, in some embodiments, the selected portion of the content may include multiple types of data (e.g., text, an image, a table, a graph, an audio, a video, a 3D object, and/or interactive content) and the same generative style may be applied to the multiple types of data. For example, when the user selects some text and images in the content and selects “Old Style” generative style, the generative style tool 130 transforms the selected text with old style type font and the selected images into black and white with some scratches.

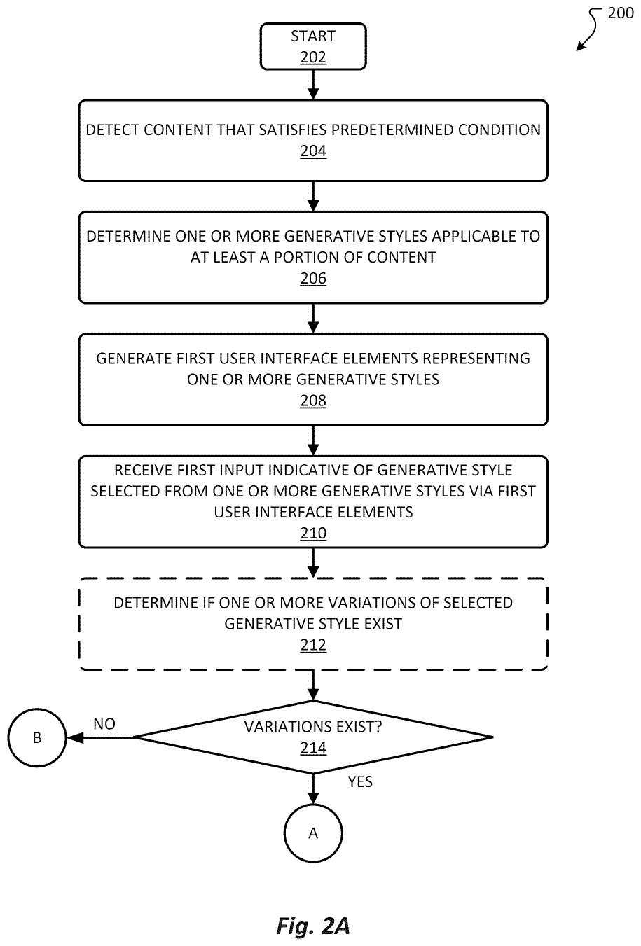

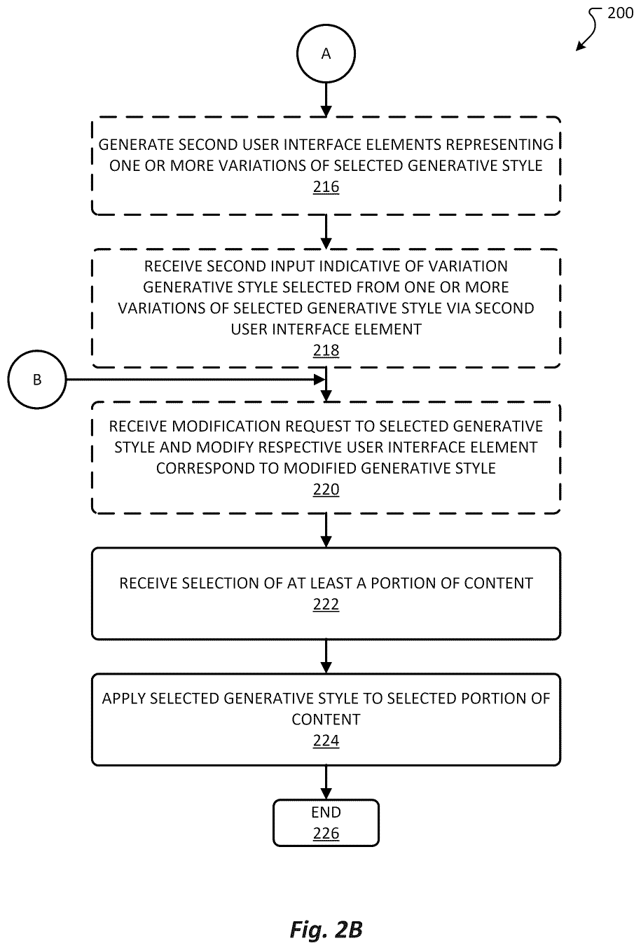

Referring now to FIGS. 2A and 2B, a method 200 for content shaping using one or more generative styles in accordance with examples of the present disclosure is provided. A general order for the steps of the method 200 is shown in FIGS. 2A and 2B. Generally, the method 200 starts at 202 and ends at 226. The method 200 may include more or fewer steps or may arrange the order of the steps differently than those shown in FIGS. 2A and 2B. In the illustrative aspect, the method 200 is performed by a computing device (e.g., a user device 120) of a user 110. However, it should be appreciated that one or more steps of the method 200 may be performed by another device (e.g., a server 160).

Specifically, in some aspects, the method 200 may be performed by a generative style tool (e.g., 130) executed on the user device 120. For example, the generative style tool 130 is communicatively coupled to a productivity application 128 executed on the computing device 120 that has content generating functionalities. For example, the computing device 120 may be, but is not limited to, a computer, a notebook, a laptop, a mobile device, a smartphone, a tablet, a portable device, a wearable device, or any other suitable computing device that is capable of executing a generative style tool (e.g., 130). For example, the server 160 may be any suitable computing device that is capable of communicating with the computing device 120. The method 200 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), a Neural Processing Unit (NPU), or other hardware device. Hereinafter, the method 200 shall be explained with reference to the systems, components, modules, software, data structures, user interfaces, etc. described in conjunction with FIG. 1 and FIGS. 4-7.

The method 200 starts at operation 202, where flow may proceed to 204. At operation 204, the generative style tool 130 detects content that satisfies a predetermined condition. For example, the predetermined condition includes the content being in a form that may be editable. To do so, the generative style tool 130 determines whether content is displayed in a content input field (e.g., where users can enter and edit content) of a productivity application. The productivity application 130 may be a word processing application, a notebook application, a presentation application, a spreadsheet application, an email application, an internet browser application, an instant messaging or chat application, a social networking application, or any other application capable of creating content, and the content may be one or more texts, documents, images, pictures, photos, videos, or audios. For example, the user may create content using the productivity application by directly inputting the content in the content input field. In other example, the user may create content the content input field by inputting prompts in a machine learning model (e.g., a generative large language model (LLM)).

At operation 206, in response to detecting the content that satisfies the predetermined condition, the generative style tool 130 determines one or more generative styles that are applicable to at least a portion of the content. Specifically, the generative style tool 130 determines the one or more generative styles based on the content and context associated with the content using a machine learning model. For example, the machine learning model may be a generative large language model (LLM), a transformer model, a diffusion model, or a multi-modal model, other type of machine learning models, or a combination of models. For example, each generative style represents one or more prompts that define one or more style features adapted to shape at least a portion of the content. The one or more style features may include generating, formatting, and/or styling text, an image, a table, a graph, an audio, a video, a 3D object, interactive content, and/or other data based on the at least a portion of the content. In some embodiments, the selected portion of the content may include multiple types of data (e.g., text, an image, a table, a graph, an audio, a video, a 3D object, and/or interactive content).

To do so, the generative style tool 130 determines a type of content, a genre or tone of content, a general topic or theme of content, and/or information contained in the content. For example, the type of content includes, but not limited to, one or more documents, spreadsheets, blog posts, emails, text messages, social media content, guides, books, video content, webinars, white papers, press releases, and/or case studies. The genre or tone of content includes, but not limited to, one or more news, social, media studies, fiction, non-fiction, essay, documentary, philosophical, humor, comedy, mystery, scientific, historical, horror, thriller, cartoons, and/or children. A general topic or theme of content includes, but not limited to, one or more technology, lifestyle, health, fitness, sports, food, cooking, beauty, business, education, family, parenting, travel, home, gardening, crafts, environment, gaming, and/or entertainment.

Additionally, the generative style tool 130 further determines the context associated with the content. For example, the context may include a type of the productivity application, user's preferences, and/or user's expectations. The type of productivity application includes, but not limited to, a word processing application, a notebook application, a presentation application, a spreadsheet application, an email application, an internet browser application, an instant messaging or chat application, and/or a social networking application. Additionally, the user's preferences and expectations may be inferred based on the content. For example, the generative style tool 130 may determine a user's particular use of style and knowledge from previous/historical contents and suggest generative styles and/or patterns related to the user based on the learned preferences and/or expectations. In other example, the generative style tool 130 may determine a type of content that the user is working on and provide suggestions accordingly. For example, if the generative style tool 130 determines that the user is drafting a patent application, the generative style tool 130 may suggest appropriate generative styles and language for drafting patent applications.

According to some embodiments, the context may further include context of the user. For example, the context of the user may include a mood of the user (e.g., captured from a camera communicatively coupled to the computing device 120), one or more devices used (e.g., a tablet, a desktop, a large display screen), an environment of the user (e.g., on a bus, in a conference room, in a meeting), and/or a mood or ambiance of the environment (e.g., professional, casual) could affect what generative styles are generated and how many generative styles are provided to the user.

In some embodiments, the generative style tool 130 may generate one or more generative styles specific for a portion of the content selected by a user. For example, the user may select a portion of the content, and the generative style tool 130 generates one or more generative styles that are applicable to the selected portion of the content. In some embodiments, the selected portion of the content may include multiple types of data (e.g., text, an image, a table, a graph, an audio, a video, a 3D object, and/or interactive content).

In certain embodiments, the generative style tool 130 may generate a new generative style upon receiving a request from a user. For example, the user may select a portion of content to create a new generative style, and the generative style tool 130 analyzes the selected portion of content and determine any style features applied to the selected portion of content. Subsequently, the generative style tool 130 generate a generative style that represents the style features, such that the user may apply the same style to a different portion of the content. It should be appreciated that, in certain embodiments, the generative style tool 130 may allow users to create a new generative style from content of a different application (e.g., different from the productivity application that contains the content detected in the operation 204).

At operation 208, the generative style tool 130 generates a first set of user interface elements that represent the one or more generative styles. Specifically, the generative style tool 130 generates the first set of user interface elements based on the content and context associated with the content using a machine learning model. For example, the machine learning model may be a generative large language model (LLM), a transformer model, a diffusion model, or a multi-modal model, other type of machine learning models, or a combination of models. Each user interface element represents the corresponding generative style and adapts to provide appropriate look and feel of the user interface elements of the first user interface elements based on the content and the context. For example, each generative style may be represented with a different look and feel of the user interface element. Various exemplary screenshots of the generative style tool 130, which includes the first user interface elements representing the generative styles, are illustrated in FIGS. 3A-3E.

At operation 210, the generative style tool 130 receives a first input that indicates a generative style selected from the one or more generative styles via the first user interface elements. For example, the user may select a generative style by clicking or touching a corresponding user interface element from the first user interface elements. However, it should be appreciated that any type of selection methods such as, but not limited to lasso, gestures, voice, and/or gaze, may be used to select the generative style. In some embodiments, the generative style tool 130 may automatically select the first input based on the previously selected generative styles. In other embodiments, the generative style tool 130 may predict and automatically select the first input based on the content and the context associated with the content and the user.

In some embodiments, at operation 212, the generative style tool 130 may further determine whether one or more variations of the generative style selected by the user exist, and if so, generate one or more variations of the selected generative style using a machine learning model. For example, the machine learning model may be a generative large language model (LLM), a transformer model, a diffusion model, or a multi-modal model, other type of machine learning models, or a combination of models. The one or more variations provide additional options that further refine the initially selected generative style. For example, as shown in the exemplary screenshots of the generative style tool 130 in FIGS. 3A and 3B, the first set of the user interface elements (e.g., “Humor”, “Joke”, “Table”, “Sarcastic”, “Ironic”, and “Summary”) is generated.

If the generative style tool 130 determines that one or more variations of the selected generative style do not exist at operation 214, the method 200 skips ahead to operation 220 in FIG. 2B. However, if the generative style tool 130 determines that one or more variations of the selected generative style exist at the operation 214, the method 200 proceeds to operation 216 in FIG. 2B.

At operation 216, in response to determining that one or more variations of the selected generative style exist, the generative style tool 130 generates a second set of user interface elements that represent the one or more variations of the selected generative style. The second set of user interface elements may be generated based on the content, the context associated with the content, and the user interface element of the selected generative style using a machine learning model. For example, the machine learning model may be a generative large language model (LLM), a transformer model, a diffusion model, or a multi-modal model, other type of machine learning models, or a combination of models.

As illustrated in the exemplary screenshots of the generative style tool 130 in FIGS. 3A and 3B, the second set of user interface elements may look and feel similar to the selected generative style from the first set of user interface elements to indicate the selected generative style to which the second set of user interface elements belongs or relates. For example, designs (e.g., colors, shapes, layout, and typefaces) and behaviors (e.g., buttons, boxes, and menus) of the second set of user interface elements may be similar to the first set of user interface elements. The similar look and feel between the first and second sets of user interface elements are easily perceived by the user. However, it should be appreciated that, in some embodiments, the second set of user interface elements may look and feel different from the first set of user interface elements to distinguish the selections of the variations from the initial first set of the user interface elements.

For example, as shown in the exemplary screenshots of the generative style tool 130 in FIGS. 3A and 3B, when the user selects “Summary” generative style from the first set of the user interface elements for generating a summary based on the content (e.g., a portion of the content selected by the user), variations of the “Summary” generative style (e.g., “Short Summary”, “Long Summary”, and “Humorous Summary”) appear as a second set of the user interface elements. The second set of the user interface elements may appear next to the first set of the user interface elements, as shown in FIG. 3A. Alternatively, the second set of the user interface elements may appear as a drop-down menu from the selected generative style, as shown in FIG. 3B.

In other example, variations of “Title” generative style from the first set of the user interface elements for generating a title may based on the content (e.g., a portion of the content selected by the user) include “Elegant Title”, “Stylish Header”, “Chic Title”, and “Sophisticate Title.” Variations of “Colorful” generative style from the first set of the user interface elements for generating an image based on the content (e.g., a portion of the content selected by the user) include “Minimalist”, “Vintage”, “Abstract”, and “Pop Art.”

In some embodiments, at operation 218, the generative style tool 130 may receive a second input indicating a variation generative style selected from the one or more variations of the selected generative style via the second set of the user interface elements. For example, the user may select a variation generative style by clicking or touching a corresponding user interface element from the second user interface elements. However, any type of selection methods such as, but not limited to lasso, gestures, voice, and/or gaze, may be used to select the variation generative style. In some embodiments, the generative style tool 130 may automatically select the second input based on the previously selected generative styles. In other embodiments, the generative style tool 130 may predict and automatically select the second input based on the content and the context associated with the content and the user. It should be appreciated that, in certain embodiments, the user may not select any of the variations from the second set of the user interface elements. Instead, the user may choose to modify the selected generative style or apply the initially selected generative style to the content by selecting at least a portion of the content, as described further below at operations 220 and 224, respectively.

At operation 220, the generative style tool 130 may receive a modification request to the selected generative style. The user can input or write any prompt (e.g., natural language prompts) directly on the user interface element that correspond to the selected generative style. In some embodiments, the generative style tool 130 updates the variations of the modified generative style accordingly. For example, the modified generative style may be “Table with Columns”, “Emphasize a word”, or “Yellow Highlighter with blue underline.” Additionally, the user may combine two or more generative styles into a single generative style (e.g., a single user interface element) by dragging a first user interface element that corresponds to a first generative style to a second user interface element that corresponds to a second generative style to modify the second generative style into the combination of the first and second generative styles. Additionally, the generative style tool 130 further changes the second user interface element to represent the combined generative styles.

At operation 222, the generative style tool 130 receives a selection of at least a portion of the content to which the selected generative style is to be applied. For example, the user may select text or brushing over an area of an image to apply the selected generative style. Alternatively, the user may select a portion of the content prior to selecting the generative style to be applied. For example, in some embodiments, the user selects a portion of the content, the generative style tool 130 generates one or more generative styles that are applicable to the selected portion of the content, the user selects a generative style, and the generative style tool 130 applies the selected generative style to the selected portion of the content.

At operation 224, the generative style tool 130 applies the selected generative style to a selected portion of the content to shape the selected portion of the content according to the one or more style features defined by the selected generative style. In some examples, the user may select background of content field of the productivity application to apply the selected generative style to the whole content. As described above, in some embodiments, the selected portion of the content may include multiple types of data (e.g., text, an image, a table, a graph, an audio, a video, a 3D object, and/or interactive content) and the same generative style may be applied to the multiple types of data. For example, when the user selects some text and images in the content and selects “Old Style” generative style, the generative style tool 130 transforms the selected text with old style type font and the selected images into black and white with some scratches. Subsequently, the method 200 may end at operation 226.

Depending on resources, capabilities, and capacity of the computing device 120 executing the productivity application 128, the generative styles may be generated from the computing device or the server 160. In some embodiments, at least some of the functions of the generative style tool 130 may be performed on the server 160 using a generative large language model (LLM), a transformer model, a diffusion model, or a multi-modal model, other type of machine learning models, or a combination of models. For example, if the content is detected on a user's mobile device, which has less resources to perform generative style generation or transformation, the generative style tool 130 may send content data to the server 160 to generate generative styles and/or apply the selected generative style. The generative styles and/or transformed content is then sent back to the user's mobile device.

Referring now to FIGS. 3A-3E, exemplary screenshots of the generative style tool 130, which includes user interface elements representing generative styles for interacting with users, are illustrated. As illustrated in FIG. 3A, the generative style tool 130 is presented as part of user interface elements of a productivity application 312 as a ribbon, which is shown as a toolbar at the top of the window in the productivity application 312 designed to help users quickly find commands that the users need to complete a task. The productivity application 312 in this example is a presentation application (e.g., Microsoft® PowerPoint®), and content 310 is created in a content field of a presentation slide. The generative style tool 130 generates a set of generative styles 302 and a set of variations 304.

As described above, based on the content and the context associated with the content, the set of generative styles 302 (e.g., “Humor”, “Joke”, “Table”, “Sarcastic”, “Ironic”, and “Summary”) is generated and is presented in the ribbon. When the user selects the “Summary” generative style, the set of variations 304 (e.g., “Short Summary”, “Long Summary”, and “Humorous Summary”) are generated and presented in the ribbon.

In the illustrative embodiment, the generative style tool 130 further includes an edit pen prompt 306 and an analyze source style 308. The edit pen prompt 306 is configured to edit a generative style selected form the set of generative styles 302 or the set of variations 304. The analyze source style 308 is configured to analyze a part of the content selected by the user to determine style associated with the selected content. As described above, the generative style tool 130 may automatically generate a new generative style and create a user interface element that represent the style extracted from the selected content.

FIG. 3B illustrates the generative style tool 130 as part of user interface elements of a productivity application 320 as a ribbon similar to the generative style tool described in FIG. 3A but in a different productivity application with different interface designs. The productivity application 320 in this example is a word processing application (e.g., Microsoft® Word®). The generative style tool 130 generates a set of generative styles 302 and a set of variations 304.

Based on the content and the context associated with the content, the set of generative styles 302 (e.g., “Summary”, “Humor”, “Joke”, “Table”, “Sarcastic”, and “Ironic”) is generated and is presented in the ribbon. When the user selects the “Summary” generative style, the set of variations 304 (e.g., “Short Summary”, “Long Summary”, and “Humorous Summary”) are generated and presented as a drop-down menu that shows a list of the variation generative styles.

Referring now to FIGS. 3C-3E, exemplary screenshots 330, 340, 350 of the generative style tool 130 similar to the generative style tool described in FIGS. 3A and 3B but in a different productivity application with different interface designs. Specifically, the exemplary screenshots 330, 340, 350 illustrate the generative style tool 130 working with a productivity application 340 to create a blog post. The productivity application 340 in this example is an internet application (e.g., Microsoft® Edge®).

As shown in the exemplary screenshot 330, a set of generative styles 332 (e.g., “Font”, “Humor”, “Title”, and “Colorful”) is generated based on the content 336 of the blog post and context associated with the content 336 and presented as a floating layer or a popup window on top of the productivity application 340, such that the user interface elements of the generative style tool 130 do not hinder or minimally hinder functional elements (e.g., content, menu tabs) of the productivity application 340. Once the user selects the “Title” generative style tab, a set of variations 334 (e.g., “Elegant Title”, “Stylish Header”, “Chic Title”, and “Sophisticate Title”) of the “Font” generative style is generated and presented below the set of generative styles 332. As shown in FIG. 3D, the user interface elements of the variations 334 (e.g., crayon icons) are similar to the user interface element of the selected “Title” generative style, indicating which generative style the set of the variations 334 belongs to or related to. In this example, the set of variations 334 provides more refined effect of the selected generative style. The user has an option to select a variation generative style from the set of variations 334 or proceed to select at least a portion of the content to apply the selected generative style from the set of the generative styles 332.

In this example, subsequent to selecting the “Title” generative style, the user selects a portion of the content 336 to transform the selected text into the “Title” generative style. Upon selecting the content 336, the selected text is modified with the “Title” generative style to generate a Title 338, as shown in FIG. 3E.

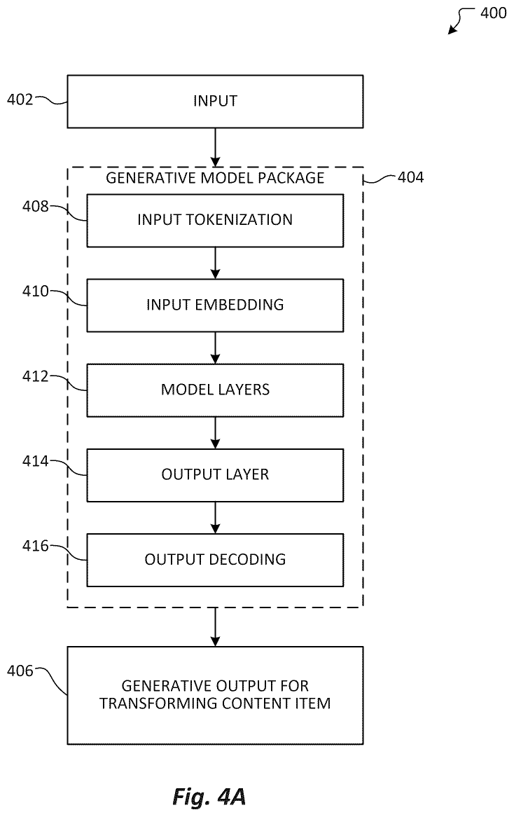

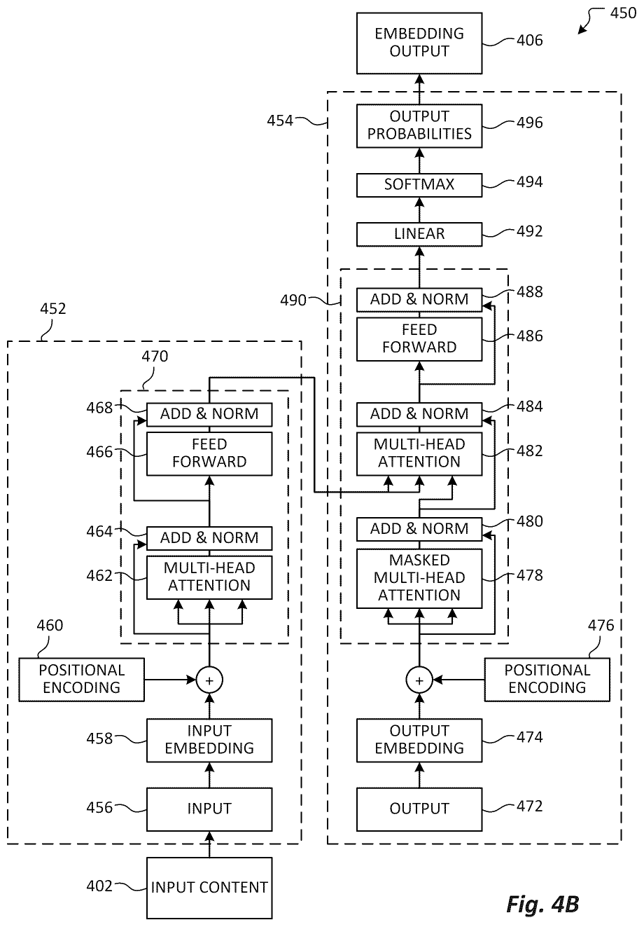

FIGS. 4A and 4B illustrate overviews of an example generative machine learning model that may be used according to aspects described herein. With reference first to FIG. 4A, conceptual diagram 400 depicts an overview of pre-trained generative model package 404 that processes an input 402 to generate model output for capturing and generatively transforming content items from a generative model output 406 (e.g., transformed content) according to aspects described herein.

In examples, generative model package 404 is pre-trained according to a variety of inputs (e.g., a variety of human languages, a variety of programming languages, and/or a variety of content types) and therefore need not be finetuned or trained for a specific scenario. Rather, generative model package 404 may be more generally pre-trained, such that input 402 includes a prompt that is generated, selected, or otherwise engineered to induce generative model package 404 to produce certain generative model output 406. It will be appreciated that input 402 and generative model output 406 may each include any of a variety of content types, including, but not limited to, text output, image output, audio output, video output, programmatic output, and/or binary output, among other examples. In examples, input 402 and generative model output 406 may have different content types, as may be the case when generative model package 404 includes a generative multimodal machine learning model.

As such, generative model package 404 may be used in any of a variety of scenarios and, further, a different generative model package may be used in place of generative model package 404 without substantially modifying other associated aspects (e.g., similar to those described herein with respect to FIGS. 1-3). Accordingly, generative model package 404 operates as a tool with which machine learning processing is performed, in which certain inputs 402 to generative model package 404 are programmatically generated or otherwise determined, thereby causing generative model package 404 to produce model output 406 that may subsequently be used for further processing.

Generative model package 404 may be provided or otherwise used according to any of a variety of paradigms. For example, generative model package 404 may be used local to a computing device (e.g., the computing device 140 in FIG. 1) or may be accessed remotely from a machine learning service (e.g., the server 160 in FIG. 1). In other examples, aspects of generative model package 404 are distributed across multiple computing devices. In some instances, generative model package 404 is accessible via an application programming interface (API), as may be provided by an operating system of the computing device and/or by the machine learning service, among other examples.

With reference now to the illustrated aspects of generative model package 404, generative model package 404 includes input tokenization 408, input embedding 410, model layers 412, output layer 414, and output decoding 416. In examples, input tokenization 408 processes input 402 to generate input embedding 410, which includes a sequence of symbol representations that corresponds to input 402. Accordingly, input embedding 410 is processed by model layers 412, output layer 414, and output decoding 416 to produce model output 406. An example architecture corresponding to generative model package 404 is depicted in FIG. 4B, which is discussed below in further detail. Even so, it will be appreciated that the architectures that are illustrated and described herein are not to be taken in a limiting sense and, in other examples, any of a variety of other architectures may be used.

FIG. 4B is a conceptual diagram that depicts an example architecture 450 of a pre-trained generative machine learning model that may be used according to aspects described herein. As noted above, any of a variety of alternative architectures and corresponding ML models may be used in other examples without departing from the aspects described herein.

As illustrated, architecture 450 processes input 402 to produce generative model output 406, aspects of which were discussed above with respect to FIG. 4A. Architecture 450 is depicted as a transformer model that includes encoder 452 and decoder 454. Encoder 452 processes input embedding 458 (aspects of which may be similar to input embedding 410 in FIG. 4A), which includes a sequence of symbol representations that corresponds to input 456. In examples, input 456 includes content data 402 corresponding to a content item.

Further, positional encoding 460 may introduce information about the relative and/or absolute position for tokens of input embedding 458. Similarly, output embedding 474 includes a sequence of symbol representations that correspond to output 472, while positional encoding 476 may similarly introduce information about the relative and/or absolute position for tokens of output embedding 474.

As illustrated, encoder 452 includes example layer 470. It will be appreciated that any number of such layers may be used, and that the depicted architecture is simplified for illustrative purposes. Example layer 470 includes two sub-layers: multi-head attention layer 462 and feed forward layer 466. In examples, a residual connection is included around each layer 462, 466, after which normalization layers 464 and 468, respectively, are included. Decoder 454 includes example layer 490. Similar to encoder 452, any number of such layers may be used in other examples, and the depicted architecture of decoder 454 is simplified for illustrative purposes. As illustrated, example layer 490 includes three sub-layers: masked multi-head attention layer 478, multi-head attention layer 482, and feed forward layer 486. Aspects of multi-head attention layer 482 and feed forward layer 486 may be similar to those discussed above with respect to multi-head attention layer 462 and feed forward layer 466, respectively. Additionally, masked multi-head attention layer 478 performs multi-head attention over the output of encoder 452 (e.g., output 472). In examples, masked multi-head attention layer 478 prevents positions from attending to subsequent positions. Such masking, combined with offsetting the embeddings (e.g., by one position, as illustrated by multi-head attention layer 482), may ensure that a prediction for a given position depends on known output for one or more positions that are less than the given position. As illustrated, residual connections are also included around layers 478, 482, and 486, after which normalization layers 480, 484, and 488, respectively, are included.

Multi-head attention layers 462, 478, and 482 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 4B (e.g., by a corresponding normalization layer 464, 480, or 484).

Feed forward layers 466 and 486 may each be a fully connected feed-forward network, which applies to each position. In examples, feed forward layers 466 and 486 each include a plurality of linear transformations with a rectified linear unit activation in between. In examples, each linear transformation is the same across different positions, while different parameters may be used as compared to other linear transformations of the feed-forward network.

Additionally, aspects of linear transformation 492 may be similar to the linear transformations discussed above with respect to multi-head attention layers 462, 478, and 482, as well as feed forward layers 466 and 486. Softmax 494 may further convert the output of linear transformation 492 to predicted next-token probabilities, as indicated by output probabilities 496. It will be appreciated that the illustrated architecture is provided in as an example and, in other examples, any of a variety of other model architectures may be used in accordance with the disclosed aspects.

Accordingly, output probabilities 496 may thus form generative model output 406 according to aspects described herein, such that the output of the generative ML model (e.g., which may include one or more semantic embeddings and one or more content items) is used as input for determining an action according to aspects described herein. In other examples, generative model output 406 is provided as generated output for transforming a captured content item.

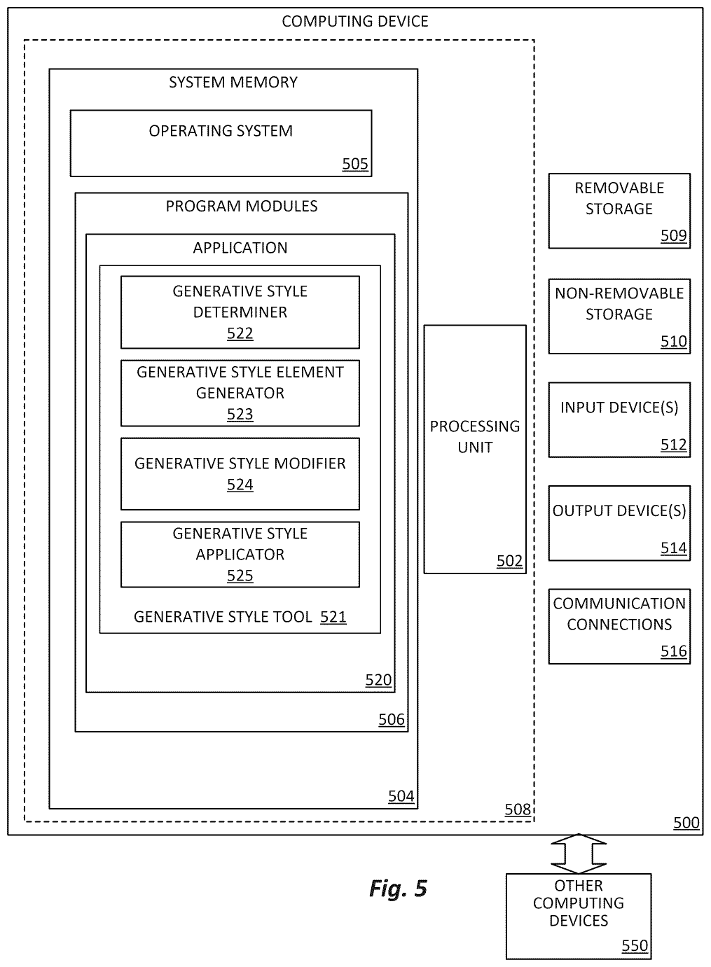

FIGS. 5-7 and the associated descriptions provide a discussion of a variety of operating environments in which aspects of the disclosure may be practiced. However, the devices and systems illustrated and discussed with respect to FIGS. 5-7 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including one or more devices associated with machine learning service (e.g., productive platform server 160), as well as computing device 140 discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store a generative style tool 521, including a generative style determiner 522, a generative style element generator 523, a generative style modifier 524, and/or a generative style applicator 525. The operating system 505, for example, may be suitable for controlling the operation of the computing device 500.

Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

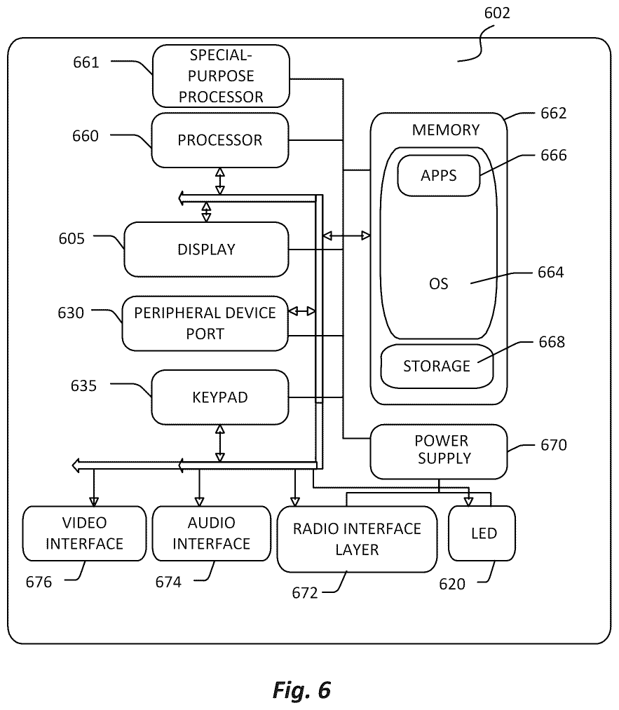

FIG. 6 illustrates a system 600 that may, for example, be a mobile computing device, such as a mobile telephone, a smart phone, wearable computer (such as a smart watch), a tablet computer, a laptop computer, and the like, with which aspects of the disclosure may be practiced. In one example, the system 600 is implemented as a “smart phone” capable of running one or more applications (e.g., browser, e-mail, calendaring, contact managers, messaging clients, games, and media clients/players). In some aspects, the system 600 is integrated as a computing device, such as an integrated personal digital assistant (PDA) and wireless phone.

In a basic configuration, such a mobile computing device is a handheld computer having both input elements and output elements. The system 600 typically includes a display 605 and one or more input buttons that allow the user to enter information into the system 600. The display 605 may also function as an input device (e.g., a touch screen display).

If included, an optional side input element allows further user input. For example, the side input element may be a rotary switch, a button, or any other type of manual input element. In alternative aspects, system 600 may incorporate more or less input elements. For example, the display 605 may not be a touch screen in some aspects. In another example, an optional keypad 635 may also be included, which may be a physical keypad or a “soft” keypad generated on the touch screen display.

In various aspects, the output elements include the display 605 for showing a graphical user interface (GUI), a visual indicator (e.g., a light emitting diode 620), and/or an audio transducer 625 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 600 also includes a non-volatile storage area 668 within the memory 662. The non-volatile storage area 668 may be used to store persistent information that should not be lost if the system 600 is powered down. The application programs 666 may use and store information in the non-volatile storage area 668, such as e-mail or other messages used by an e-mail application, and the like. A synchronization application (not shown) also resides on the system 600 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the system 600 described herein (e.g., a content capture manager, a content transformer, etc.).

The system 600 has a power supply 670, which may be implemented as one or more batteries. The power supply 670 might further include an external power source, such as an AC adapter or a powered docking cradle that supplements or recharges the batteries.

The system 600 may also include a radio interface layer 672 that performs the function of transmitting and receiving radio frequency communications. The radio interface layer 672 facilitates wireless connectivity between the system 600 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with aspects of the present disclosure, the microphone may also serve as an audio sensor to facilitate control of notifications, as will be described below. The system 600 may further include a video interface 676 that enables an operation of an on-board camera 630 to record still images, video stream, and the like.

It will be appreciated that system 600 may have additional features or functionality. For example, system 600 may also include additional data storage devices (removable and/or non-removable) such as, magnetic disks, optical disks, or tape. Such additional storage is illustrated in FIG. 6 by the non-volatile storage area 668.

Data/information generated or captured and stored via the system 600 may be stored locally, as described above, or the data may be stored on any number of storage media that may be accessed by the device via the radio interface layer 672 or via a wired connection between the system 600 and a separate computing device associated with the system 600, for example, a server computer in a distributed computing network, such as the Internet. As should be appreciated, such data/information may be accessed via the radio interface layer 672 or via a distributed computing network. Similarly, such data/information may be readily transferred between computing devices for storage and use according to any of a variety of data/information transfer and storage means, including electronic mail and collaborative data/information sharing systems.

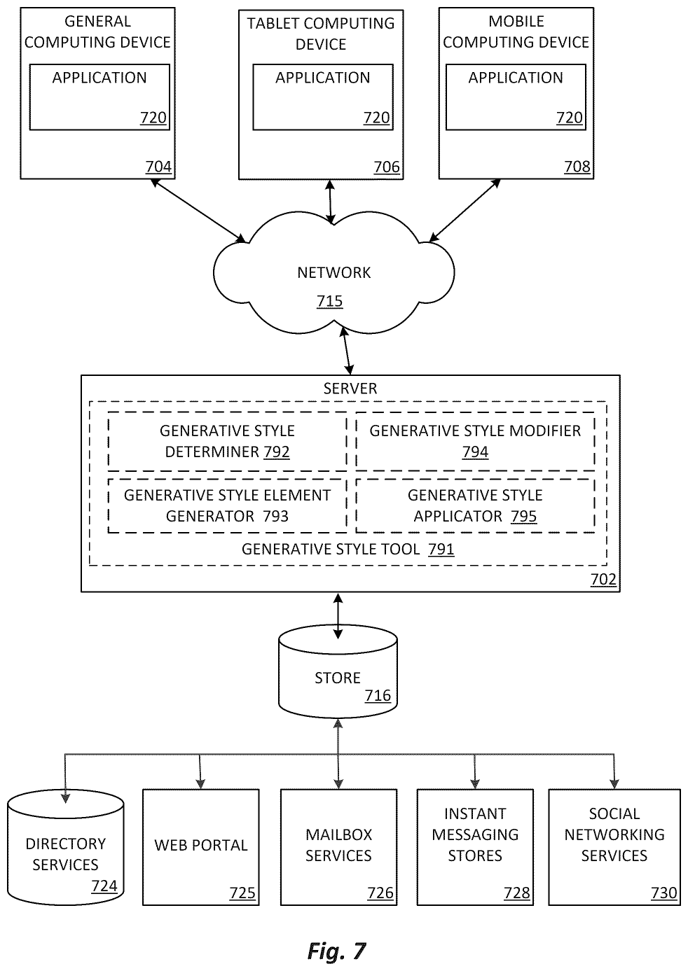

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 724, a web portal 725, a mailbox service 726, an instant messaging store 728, or a social networking site 730.

An application 720 (e.g., similar to the application 520) may be employed by a client that communicates with server device 702. Additionally, or alternatively, a generative style tool 791, including a generative style determiner 792, a generative style element generator 793, a generative style modifier 794, and/or a generative style applicator 795 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these examples of the computing devices may obtain content from the store 716, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for content shaping using one or more generative styles is provided. The method may include determining the one or more generative styles applicable to at least a portion of content based on the content and the context associated with the content, the one or more generative styles representing one or more style features adapted to shape the at least a portion of the content, generating first user interface elements representing the one or more generative styles based on the content and the context associated with the content, receiving a first generative style selected from the one or more generative styles via the first user interface elements, applying the selected generative style to a selected portion of the content, and causing a display of the content transformed based on the selected generative style.

In accordance with at least one aspect of the above method, the method may include where generating the first user interface elements representing the one or more generative styles comprises generating the first user interface elements representing the one or more generative styles based on the content and the context associated with the content.

In accordance with at least one aspect of the above method, the method may further include determining whether one or more variations of the first generative style exist, and in response to determining that the one or more variations of the first generative style exist, generating a second user interface elements representing the one or more variations of the first generative style.

In accordance with at least one aspect of the above method, the method may include where applying the selected the generative style to the selected portion of the content comprises: receiving a second generative style from the one or more variations of the first generative style via the second user interface elements, and applying the second generative style to the selected portion of the content.

In accordance with at least one aspect of the above method, the method may further include receiving a modification to the first generative style via a user input.

In accordance with at least one aspect of the above method, the method may include where the user input includes modifying one or more style features associated with the first generative style.

In accordance with at least one aspect of the above method, the method may include where the user input includes dragging a third generative style of the one or more generative styles to the first generative style of the one or more generative styles to combine the first and third generative styles.

In accordance with at least one aspect of the above method, the method may include where determining the one or more generative styles applicable to at least a portion of content comprises determining the one or more generative styles applicable to at least a portion of content using a generative model, the generative model is trained to output one or more style features suggested for shaping the content.

In accordance with at least one aspect of the above method, the method may include where the one or more style features includes generating, formatting, and/or styling text, an image, a table, a graph, an audio, a video, a 3D object, interactive content, and/or other data based on the at least a portion of the content.

In accordance with at least one aspect of the above method, the method may include where the first user interface elements are communicatively coupled to an application that has the content.

In accordance with at least one aspect of the above method, the method may include where applying the selected generative style to the selected portion of the content comprises applying the selected generative style to the selected portion of the content directly in the application.

In accordance with at least one example of the present disclosure, a computing device for content shaping using one or more generative styles is provided. The computing device may include a processor and a memory having a plurality of instructions stored thereon that, when executed by the processor, causes the computing device to determine the one or more generative styles applicable to at least a portion of content based on the content and the context associated with the content, the one or more generative styles representing one or more style features adapted to shape the at least a portion of the content, generate first user interface elements representing the one or more generative styles based on the content and the context associated with the content, receive a first generative style selected from the one or more generative styles via the first user interface elements, apply the selected generative style to a selected portion of the content, and cause a display of the content transformed based on the selected generative style.

In accordance with at least one aspect of the above computing device, the computing device may include where to generate the first user interface elements representing the one or more generative styles comprises to generate the first user interface elements representing the one or more generative styles based on the content and the context associated with the content.

In accordance with at least one aspect of the above computing device, the computing device may include where the plurality of instructions, when executed, further cause the computing device to: determine whether one or more variations of the first generative style exist, and in response to determination that the one or more variations of the first generative style exist, generate a second user interface elements representing the one or more variations of the first generative style.

In accordance with at least one aspect of the above computing device, the computing device may include where to apply the selected the generative style to the selected portion of the content comprises to: receive a second generative style from the one or more variations of the first generative style via the second user interface elements, and apply the second generative style to the selected portion of the content.

In accordance with at least one aspect of the above computing device, the computing device may include where to determine the one or more generative styles applicable to at least a portion of content comprises to determine the one or more generative styles applicable to at least a portion of content using a generative model, the generative model is trained to output one or more style features suggested for shaping the content.

In accordance with at least one aspect of the above computing device, the computing device may include where the one or more style features includes generating, formatting, and/or styling text, an image, a table, a graph, an audio, a video, a 3D object, interactive content, and/or other data based on the at least a portion of the content.

In accordance with at least one example of the present disclosure, a method for content shaping using one or more generative styles is provided. The method may include determining the one or more generative styles applicable to at least a portion of content created in an application based on the content and the context associated with the content, the one or more generative styles representing one or more style features adapted to shape the at least a portion of the content, generating first user interface elements representing the one or more generative styles based on the content and the context associated with the content, causing a display of the first user interface elements, receiving a first generative style selected from the one or more generative styles via the first user interface elements, determining whether one or more variations of the first generative style exist, in response to determining that the one or more variations of the first generative style exist, generating a second user interface element representing the one or more variations of the first generative style, and causing a display of the second user interface elements.

In accordance with at least one aspect of the above method, the method may include where causing the display of the first user interface elements comprises causing the display of the first user interface elements as part of user interface elements of the application, and causing the display of the second user interface elements comprises causing the display of the second user interface elements as part of user interface elements of the application.

In accordance with at least one aspect of the above method, the method may include where causing the display of the first user interface elements comprises causing the display of the first user interface elements as a popup window on top of the application, and causing the display of the second user interface elements comprises causing the display of the second user interface elements as a popup window on top of the application.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for content shaping using one or more generative styles, the method comprising:
determining the one or more generative styles applicable to at least a portion of content based on the content and the context associated with the content, the one or more generative styles representing one or more style features adapted to shape the at least a portion of the content;
generating first user interface elements representing the one or more generative styles based on the content and the context associated with the content;
receiving a first generative style selected from the one or more generative styles via the first user interface elements;
applying the selected generative style to a selected portion of the content; and
causing a display of the content transformed based on the selected generative style.

2. The method of claim 1, wherein generating the first user interface elements representing the one or more generative styles comprises generating the first user interface elements representing the one or more generative styles based on the content and the context associated with the content.

3. The method of claim 1, further comprising:
determining whether one or more variations of the first generative style exist; and
in response to determining that the one or more variations of the first generative style exist, generating a second user interface elements representing the one or more variations of the first generative style.

4. The method of claim 3, wherein applying the selected the generative style to the selected portion of the content comprises:
receiving a second generative style from the one or more variations of the first generative style via the second user interface elements; and
applying the second generative style to the selected portion of the content.

5. The method of claim 1, further comprising receiving a modification to the first generative style via a user input.

6. The method of claim 5, wherein the user input includes modifying one or more style features associated with the first generative style.

7. The method of claim 5, wherein the user input includes dragging a third generative style of the one or more generative styles to the first generative style of the one or more generative styles to combine the first and third generative styles.

8. The method of claim 1, wherein determining the one or more generative styles applicable to at least a portion of content comprises determining the one or more generative styles applicable to at least a portion of content using a generative model, the generative model is trained to output one or more style features suggested for shaping the content.

9. The method of claim 1, wherein the one or more style features includes generating, formatting, and/or styling text, an image, a table, a graph, an audio, a video, a 3D object, interactive content, and/or other data based on the at least a portion of the content.

10. The method of claim 1, wherein the first user interface elements are communicatively coupled to an application that has the content.

11. The method of claim 10, wherein applying the selected generative style to the selected portion of the content comprises applying the selected generative style to the selected portion of the content directly in the application.

12. A computing device for content shaping using one or more generative styles, the computing device comprising:
a processor; and
a memory having a plurality of instructions stored thereon that, when executed by the processor, causes the computing device to:
determine the one or more generative styles applicable to at least a portion of content based on the content and the context associated with the content, the one or more generative styles representing one or more style features adapted to shape the at least a portion of the content;
generate first user interface elements representing the one or more generative styles based on the content and the context associated with the content;
receive a first generative style selected from the one or more generative styles via the first user interface elements;
apply the selected generative style to a selected portion of the content; and
cause a display of the content transformed based on the selected generative style.

13. The computing device of claim 12, wherein to generate the first user interface elements representing the one or more generative styles comprises to generate the first user interface elements representing the one or more generative styles based on the content and the context associated with the content.

14. The computing device of claim 12, wherein the plurality of instructions, when executed, further cause the computing device to:
determine whether one or more variations of the first generative style exist; and
in response to determination that the one or more variations of the first generative style exist, generate a second user interface elements representing the one or more variations of the first generative style.

15. The computing device of claim 14, wherein to apply the selected the generative style to the selected portion of the content comprises to:
receive a second generative style from the one or more variations of the first generative style via the second user interface elements; and
apply the second generative style to the selected portion of the content.

16. The computing device of claim 12, wherein to determine the one or more generative styles applicable to at least a portion of content comprises to determine the one or more generative styles applicable to at least a portion of content using a generative model, the generative model is trained to output one or more style features suggested for shaping the content.

17. The computing device of claim 12, wherein the one or more style features includes generating, formatting, and/or styling text, an image, a table, a graph, an audio, a video, a 3D object, interactive content, and/or other data based on the at least a portion of the content.

18. A method for content shaping using one or more generative styles, the method comprising:
determining the one or more generative styles applicable to at least a portion of content created in an application based on the content and the context associated with the content, the one or more generative styles representing one or more style features adapted to shape the at least a portion of the content;
generating first user interface elements representing the one or more generative styles based on the content and the context associated with the content;
causing a display of the first user interface elements;
receiving a first generative style selected from the one or more generative styles via the first user interface elements;
determining whether one or more variations of the first generative style exist;
in response to determining that the one or more variations of the first generative style exist, generating a second user interface element representing the one or more variations of the first generative style; and
causing a display of the second user interface elements.

19. The method of claim 18, wherein:
causing the display of the first user interface elements comprises causing the display of the first user interface elements as part of user interface elements of the application; and
causing the display of the second user interface elements comprises causing the display of the second user interface elements as part of user interface elements of the application.

20. The method of claim 18, wherein:
causing the display of the first user interface elements comprises causing the display of the first user interface elements as a popup window on top of the application; and
causing the display of the second user interface elements comprises causing the display of the second user interface elements as a popup window on top of the application.
